(19) United States
(12) Patent Application Publication
(10) Pub. No.: US 2018/0192823 A1
(43) Pub. Date: Jul. 12, 2018

(54) COOKING GRILL WITH DISPOSABLE GREASE TRAY

(71) Applicant: Bull Outdoor Products, Inc., Lodi, CA (US)

(72) Inventor: Mark Jamal Nureddine, Lodi, CA (US)

(73) Assignee: Bull Outdoor Products, Inc., Lodi, CA (US)

(21) Appl. No.: 15/405,220

(22) Filed: Jan. 12, 2017

(51) Int. Cl. A47J 37/07; A23L 5/10

(52) U.S. Cl. CPC A47J 37/0786; A23V 2002/00; A23L 5/10

(57) ABSTRACT

A cooking grill combination has a grill assembly, a grill assembly grease tray and a disposable grease tray. The grill assembly has a cooking grill adapted for grilling food stuffs. The grill assembly grease tray is disposed below the cooking grill in a grill assembly grease tray reservoir for accepting and retaining cooking grease dripping off of food stuffs being cooked on the cooking grill. The disposable grease tray is sized and dimensioned to be retained within the grill assembly grease tray reservoir such it accepts and retains cooking grease dripping off of meats or other food stuffs being cooked while preventing such cooking grease dripping off of meats or other food stuffs from accumulating on the grill assembly grease tray. The disposable grease tray is adapted to be lifted out of the grill assembly grease tray reservoir without spilling grease accumulated within the disposable grease tray.

### BACKGROUND

Cooking grill assemblies, such are used in outdoor barbecuing and restaurant kitchens, commonly have a permanent, pull-out grill assembly grease tray disposed below the cooking grill. The grill assembly grease tray is adapted to catch and retain cooking greases and other juices which are exuded from meats and other foodstuffs cooked on the grill. Such cooking grill assemblies are illustrated in FIGS. 1, 2 and 5.

A problem with such grill assembly grease trays arises when the user attempts to dispose of the grease on the grill assembly grease tray and then clean the grill assembly grease tray for reuse. Because such grill assembly grease trays are typically made from steel or other metals and are usually attached to their cooking grill assemblies, they are heavy and awkward to remove from their cooking grill assemblies and difficult to clean. Moreover, because of the excessive weight (especially after being filled with cooking grease) and awkwardness of grill assembly grease trays, disposing of accumulated cooking grease from grill assembly grease trays frequently results in grease spills.

Therefore, there is a need for a way to avoid the aforementioned problems in the prior art.

### SUMMARY OF THE INVENTION

The present invention satisfies this need. In one aspect, the invention is a combination comprising: a) a grill assembly for grilling meats or other foodstuffs, the grill assembly having a cooking grill; b) a grill assembly grease tray disposed within the grill assembly below the cooking grill for accepting and retaining cooking grease dripping off of meats or other foodstuffs being cooked on the cooking grill, the grill assembly grease tray having a bottom wall and side walls which provide a grill assembly grease tray reservoir; and c) a disposable grease tray sized and dimensioned to be retained within the grill assembly grease tray reservoir and to accept and retain cooking grease dripping off of meats or other foodstuffs being cooked on the cooking grill while preventing such cooking grease dripping off of meats or other foodstuffs from accumulating on the grill assembly grease tray, the disposable grease tray being adapted to be lifted out of the grill assembly grease tray reservoir without spilling grease accumulated within the disposable grease tray.

In another aspect, the invention is a method of using the combination described above.

In another aspect, the invention is a disposable grease tray useable in the combination and method described above.

### DRAWINGS

These and other features, aspects and advantages of the present invention will become better understood with reference to the following description, appended claims, and accompanying drawings where:

FIG. 1 is a perspective view of a cooking grill assembly of the prior art;

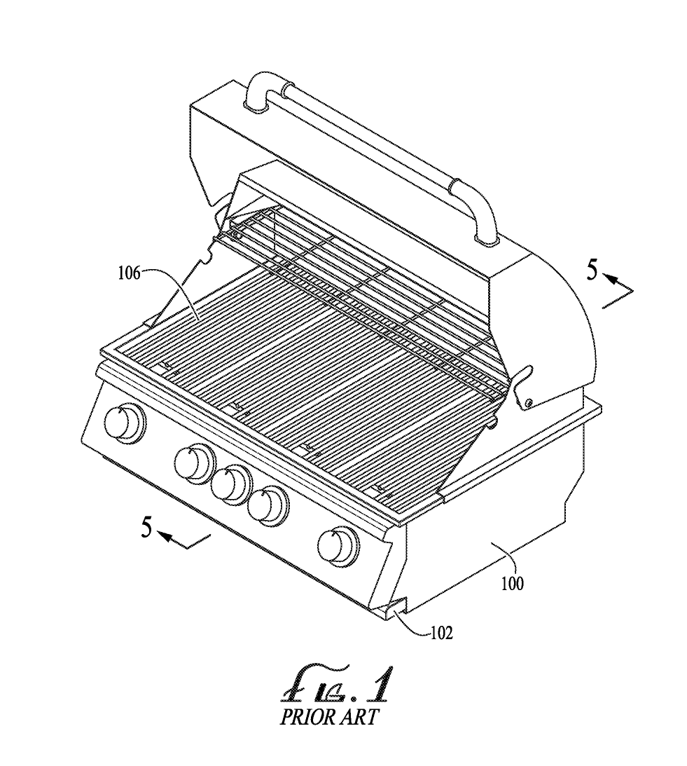

FIG. 2 is a perspective view of the cooking grill assembly illustrated in FIG. 1, showing its grill assembly grease tray in an open position;

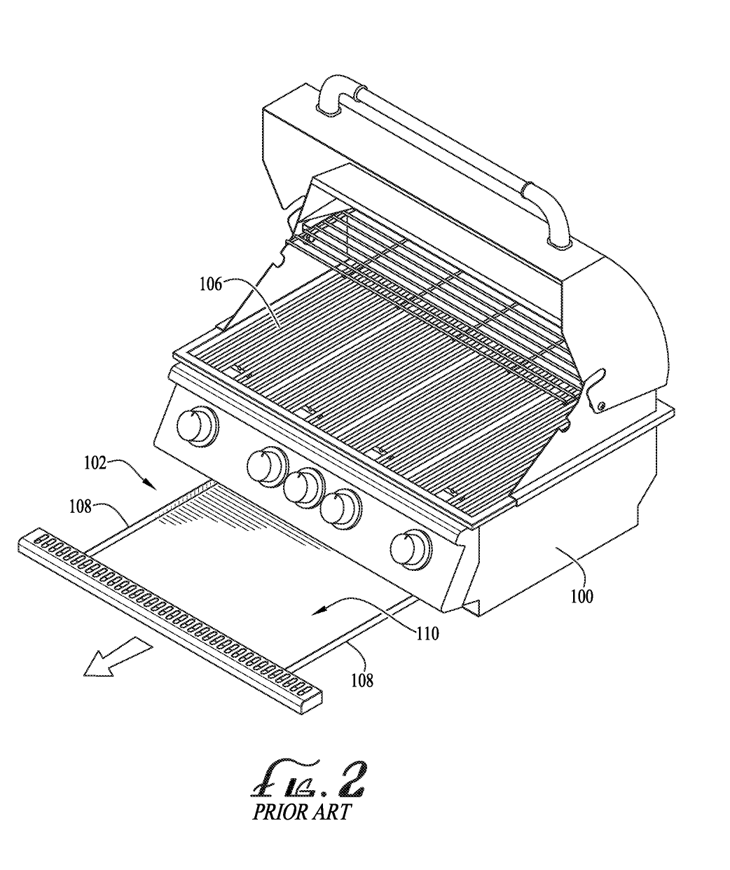

FIG. 3 is a perspective view of a combination having features of the invention;

FIG. 4 is a perspective view of a disposable grease tray having features of the invention;

FIG. 5 is a cut-way side view illustrating the use of the cooking grill assembly illustrated in FIG. 1; and

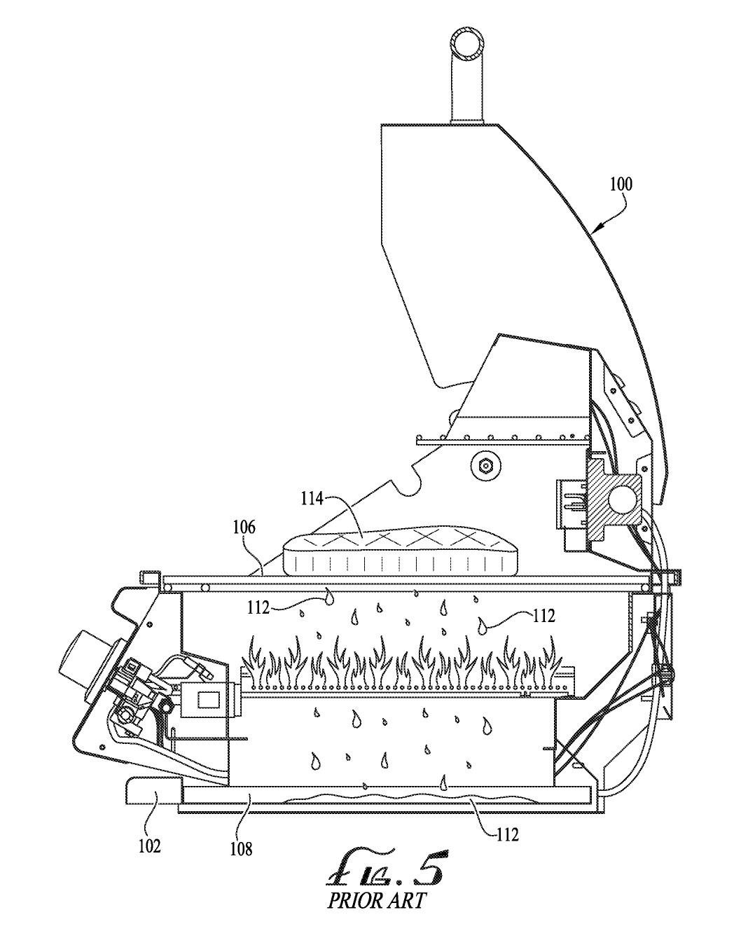

FIG. 6 is a cut-away side view illustrating the use of the combination illustrated in FIG. 3.

### DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

Definitions

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

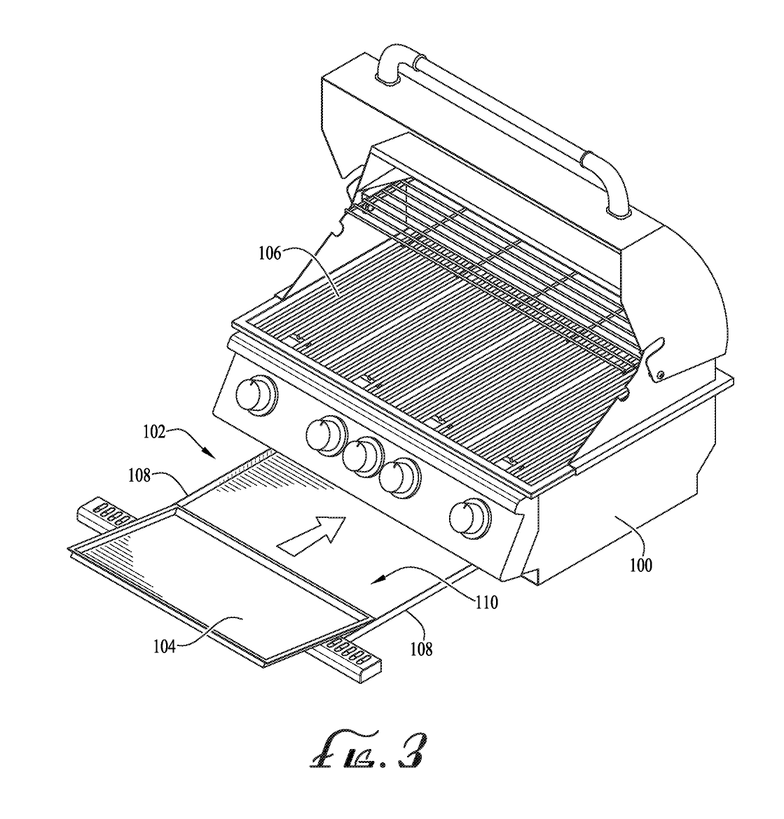

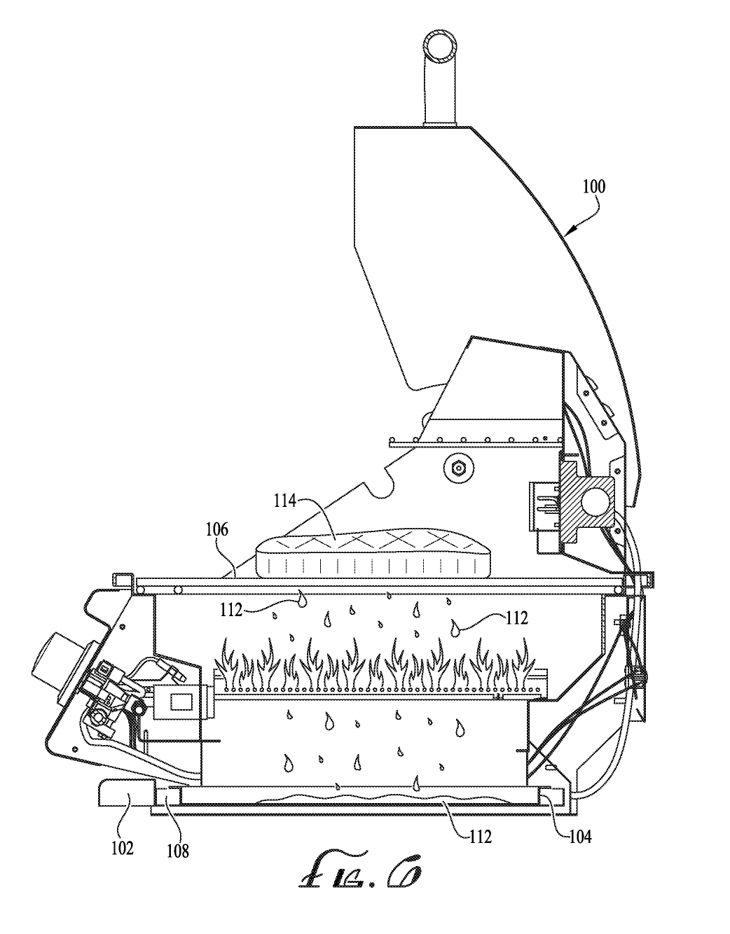

In one aspect, the invention is a combination comprising: a grill assembly 100, a grill assembly grease tray 102 and a disposable grease tray 104. This aspect is illustrated in FIGS. 3 and 6.

The grill assembly 100 is adapted for grilling foodstuffs 114, such as meats and vegetables, typically in an outdoor environment or in a restaurant kitchen. The grill assembly 100 comprises a cooking grill 106 fired by charcoal (when adapted for use in an outdoor environment) or by a petroleum gas, such as natural gas, methane, ethane, propane and/or butane.

The grill assembly grease tray 102 is disposed within the grill assembly 100 below the cooking grill 106 for accepting and retaining cooking grease 112 dripping off of meats or other foodstuffs 114 being cooked on the cooking grill 106.

The grill assembly grease tray 102 has side walls 108 to provide a grill assembly grease tray reservoir 110.

The disposable grease tray 104 is sized and dimensioned to be retained within the grill assembly grease tray reservoir 110 such that the disposable grease tray 104 accepts and retains cooking grease 112 dripping off of meats or other foodstuffs 114 being cooked on the cooking grill 106 while preventing such cooking grease 112 dripping off of meats or other foodstuffs 114 from accumulating on the grill assembly grease tray 102.

The disposable grease tray 104 is not physically attached to the cooking grill assembly 100 and is otherwise adapted to be lifted out of the grill assembly grease tray reservoir 110 without spilling grease 112 accumulated within the disposable grease tray 104.

In a second aspect, the invention is a method of employing a grill assembly 100 for grilling meats or other foodstuffs 114, wherein the grill assembly 100 comprises a cooking grill 106 and a grill assembly grease tray 102 disposed within the grill assembly 100 below the cooking grill 106 for accepting and retaining cooking grease 112 dripping off of meats or other foodstuffs 114 being cooked on the cooking grill 106, the grill assembly grease tray 102 having side walls 108 to provide a grill assembly grease tray reservoir 110, the method comprising the steps of:

a) providing a disposable grease tray 104 sized and dimensioned to be retained within the grill assembly grease tray reservoir 110 such that the disposable grease tray 104 accepts and retains cooking grease 112 dripping off of meats or other foodstuffs 114 being cooked on the cooking grill 106 while preventing such cooking grease 112 dripping off of meats or other foodstuffs 114 from accumulating on the grill assembly grease tray 102, the disposable grease tray 104 being adapted to be lifted out of the grill assembly grease tray reservoir 110 without spilling grease 112 disposed within the disposable grease tray 104;

b) placing the disposable grease tray 104 within the grill assembly grease tray reservoir 110;

c) cooking meats or other foodstuffs 114 on the cooking grill 106;

d) accepting and retaining cooking grease 112 dripping off of meats or other foodstuffs 114 being cooked on the cooking grill 106 while preventing such cooking grease 112 dripping off of meats or other foodstuffs 114 from accumulating on the grill assembly grease tray 102;

e) lifting the disposable grease tray 104 with grease 112 retained on the disposable grease tray 104 out of the grill assembly grease tray reservoir 110;

f) disposing the grease 112 retained on the disposable grease tray 104; and

g) disposing the disposable grease tray 104.

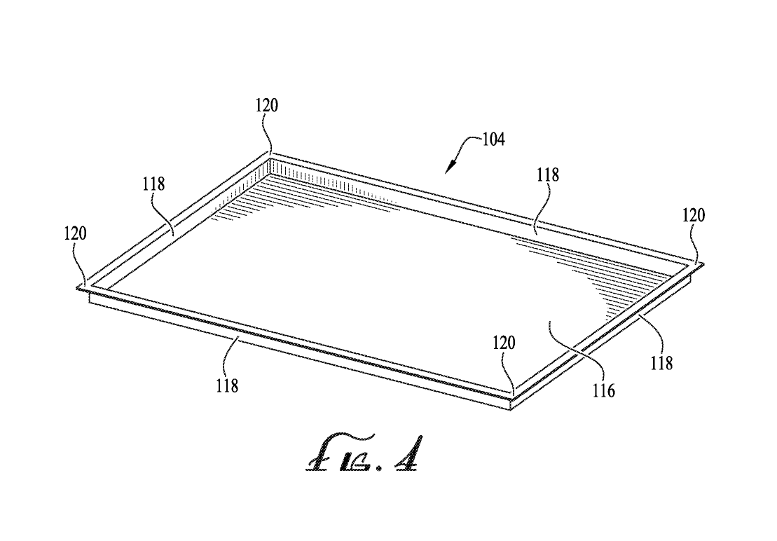

In a third aspect, the invention is a disposable grease tray 104 employable in a grill assembly 100 comprising a cooking grill 106 and adapted for grilling foodstuffs 114, such as meats and vegetables, typically in an outdoor environment. Such disposable grease tray 104 is illustrated in FIGS. 3, 4 and 6. The grill assembly 100 further comprising a grill assembly grease tray 102 disposed below the cooking grill 106 for accepting and retaining cooking grease 112 dripping off of meats or other foodstuffs 114 being cooked on the cooking grill 106. The grill assembly grease tray 102 has side walls 108 to provide a grill assembly grease tray reservoir 110 with specific dimensions.

The disposable grease tray 104 has a floor 116, side walls 118, and corners 120 and is adapted to be lifted out of the grill assembly grease tray reservoir 110. The floor 116 and side walls 118 of the disposable grease tray 104 have dimensions adapted to sufficiently match the specific dimensions of the grill assembly grease tray reservoir 110 so that the disposable grease tray 104 is sized and dimensioned to (1) be retained within the grill assembly grease tray reservoir 110 and (2) accept and retain cooking grease 112 dripping off of meats or other foodstuffs 114 being cooked on the cooking grill 106 while preventing such cooking grease 112 dripping off of meats or other foodstuffs 114 from accumulating on the grill assembly grease tray 102. Typically, the disposable grease tray 104 is between about 20 inches to about 30 inches long, between about 12 inches to 20 inches wide, with side walls 118 that are between about 0.5 inches to about 1 inch tall. Preferably, the disposable grease tray 104 is between 21 and 28 inches long, 15 and 9/16 inches wide, with side walls 118 that are ⅞ inches tall.

The disposable grease tray 104 has sufficient strength to allow the disposable grease tray 104 to be lifted out of the grill assembly grease tray reservoir 110 without spilling grease 112 disposed with the disposable grease tray 104, but not so much strength to prevent the user from easily folding or otherwise crumpling the disposable grease tray 104 by hand.

Typically, the disposable grease tray 104 is made from a single sheet of aluminum alloy, such as an alloy comprising greater than 95% aluminum, typically about 99% aluminum (such as 8011 aluminum). Such alloys also typically comprise one or more of S, Mn, Mg, Cr, Zn and Ti. For such aluminum alloys, the floor 116 and side walls 118 of the disposable grease tray 104 typically have a thickness of between about 0.045 mm and about 0.055 mm, and preferably between about 0.05 mm and about 0.05 mm. In one preferred embodiment, the thickness of the floor 116 and side walls 118 is about 0.05 mm. The corners 120 of the disposable grease tray 104 can have a thickness between about 0.2 mm to about 0.4 mm, being thicker than the sheet of aluminum used for forming the tray 104 due to crunching at the corners when forming the tray 104. Preferably, the corners 120 of the disposable grease tray 104 have a thickness between about 0.2 mm to about 0.3 mm.

The invention avoids the above-described problems in the prior art. Because the disposable grease tray 104 is lighter than the permanent grease tray and is not physically attached to the cooking grill assembly 100, the disposable grease tray 104 is much easier to remove from the cooking grill assembly 100 and transport the cooking grease 112 to a suitable disposal site. Because the disposable grease tray 104 is disposable, it does not need to be cleaned—merely thrown away. Moreover, since the disposable grease tray 104 prevents cooking grease 112 dripping off of meats or other foodstuffs 114 from accumulating on the grill assembly grease tray 102, the grill assembly grease tray 102 does not have to be removed from the cooking grill assembly 100 and cleaned after every use.

What is claimed is:

1. A combination comprising:
a) a grill assembly for grilling meats or other foodstuffs, the grill assembly having a cooking grill;
b) a grill assembly grease tray disposed within the grill assembly below the cooking grill for accepting and retaining cooking grease dripping off of meats or other foodstuffs being cooked on the cooking grill, the grill assembly grease tray having a bottom wall and side walls which provide a grill assembly grease tray reservoir; and
c) a disposable grease tray comprising a floor and side walls, sized and dimensioned to be retained within the grill assembly grease tray reservoir and to accept and retain cooking grease dripping off of meats or other foodstuffs being cooked on the cooking grill while preventing such cooking grease dripping off of meats or other foodstuffs from accumulating on the grill assembly grease tray, the disposable grease tray being adapted to be lifted out of the grill assembly grease tray reservoir without spilling grease accumulated within the disposable grease tray.

2. The combination of claim 1, wherein the disposable grease tray has an aluminum alloy composition with an aluminum content greater than 95% and the floor and side walls each have a thickness between about 0.045 mm and about 0.055 mm.

3. The combination of claim 1, wherein the disposable grease tray has an aluminum alloy composition with an aluminum content greater than 95% and the floor and side walls each have a thickness between about 0.05 mm and about 0.05 mm.

4. The combination of claim 1, wherein the disposable grease tray has an aluminum alloy composition with an aluminum content greater than 95% and the floor and side walls each have a thickness about 0.051 mm.

5. The combination of claim 1, wherein the disposable grease tray has an aluminum alloy composition with an aluminum content of about 99% and the floor and side walls each have a thickness between about 0.045 mm and about 0.055 mm.

6. The combination of claim 1, wherein the disposable grease tray has an aluminum alloy composition with an aluminum content of about 99% and the floor and side walls each have a thickness between about 0.05 mm and about 0.05 mm.

7. The combination of claim 1, wherein the disposable grease tray has an aluminum alloy composition with an aluminum content of about 99% and the floor and side walls each have a thickness about 0.05 mm.

8. A method of employing a grill assembly for grilling meats or other foodstuffs, wherein the grill assembly comprises a cooking grill and a grill assembly grease tray disposed within the grill assembly below the cooking grill for accepting and retaining cooking grease dripping off of meats or other foodstuffs being cooked on the cooking grill, the grill assembly grease tray having side walls to provide a grill assembly grease tray reservoir, the method comprising the steps of:
a) providing a disposable grease tray sized and dimensioned to be retained within the grill assembly grease tray reservoir such that the disposable grease tray accepts and retains cooking grease dripping off of meats or other foodstuffs being cooked on the cooking grill while preventing such cooking grease dripping off of meats or other foodstuffs from accumulating on the grill assembly grease tray, the disposable grease tray being adapted to be lifted out of the grill assembly grease tray reservoir without spilling grease disposed within the disposable grease tray;
b) placing the disposable grease tray within the grill assembly grease tray reservoir such that the disposable grease tray accepts and retains cooking grease dripping off of meats or other foodstuffs being cooked on the cooking grill while preventing such cooking grease dripping off of meats or other foodstuffs from accumulating on the grill assembly grease tray;
c) cooking meats or other foodstuffs on the cooking grill;
d) accepting and retaining cooking grease dripping off of meats or other foodstuffs being cooked on the cooking grill while preventing such cooking grease dripping off of meats or other foodstuffs from accumulating on the grill assembly grease tray;
e) lifting the disposable grease tray with grease retained on the disposable grease tray out of the grill assembly grease tray reservoir;
f) disposing the grease retained on the disposable grease tray; and
g) disposing the disposable grease tray.

9. The method of claim 8, wherein the disposable grease tray has an aluminum alloy composition with an aluminum content greater than 95% and the floor and side walls each have a thickness between about 0.045 mm and about 0.055 mm.

10. The method of claim 8, wherein the disposable grease tray has an aluminum alloy composition with an aluminum content greater than 95% and the floor and side walls each have a thickness between about 0.05 mm and about 0.05 mm.

11. The method of claim 8, wherein the disposable grease tray has an aluminum alloy composition with an aluminum content greater than 95% and the floor and side walls each have a thickness about 0.05 mm.

12. The method of claim 8, wherein the disposable grease tray has an aluminum alloy composition with an aluminum content of about 99% and the floor and side walls each have a thickness between about 0.045 mm and about 0.055 mm.

13. The method of claim 8, wherein the disposable grease tray has an aluminum alloy composition with an aluminum content of about 99% and the floor and side walls each have a thickness between about 0.05 mm and about 0.05 mm.

14. The method of claim 8, wherein the disposable grease tray has an aluminum alloy composition with an aluminum content of about 99% and the floor and side walls each have a thickness about 0.05 mm.

15. A disposable grease tray employable in a grill assembly comprising a cooking grill and a grill assembly grease tray disposed within the grill assembly below the cooking grill for accepting and retaining cooking grease dripping off of meats or other foodstuffs being cooked on the cooking grill, the grill assembly grease tray having side walls to provide a grill assembly grease tray reservoir, the grill assembly grease tray reservoir having specific dimensions, the disposable grease tray comprising:
a) a floor and side walls;
b) dimensions adapted to match the specific dimensions of the grill assembly grease tray reservoir such that disposable grease tray is sized and dimensioned to be retained within the grill assembly grease tray reservoir so that the disposable grease tray can accept and retain cooking grease dripping off of meats or other foodstuffs being cooked on the cooking grill while preventing such cooking grease dripping off of meats or other foodstuffs from accumulating on the grill assembly grease tray, the disposable grease tray being adapted to be lifted out of the grill assembly grease tray reservoir without spilling grease accumulated within the disposable grease tray; and
(b) an aluminum alloy composition having an aluminum alloy composition with an aluminum content greater than 95%, wherein the floor and side walls each have a thickness between about 0.045 mm and about 0.055 mm.

16. The disposable grease tray of claim 15 wherein the aluminum alloy composition with an aluminum content greater than 95% and the floor and side walls each have a thickness between about 0.05 mm and about 0.05 mm.

17. The disposable grease tray of claim 15, wherein the aluminum alloy composition with an aluminum content greater than 95% and the floor and side walls each have a thickness about 0.051 mm.

18. The disposable grease tray of claim 15, wherein the aluminum alloy composition with an aluminum content of about 99% and the floor and side walls each have a thickness between about 0.045 mm and about 0.055 mm.

19. The disposable grease tray of claim 15 wherein the aluminum alloy composition with an aluminum content of about 99% and the floor and side walls each have a thickness between about 0.05 mm and about 0.05 mm.

20. The disposable grease tray of claim 15, wherein the aluminum alloy composition with an aluminum content of about 99% and the floor and side walls each have a thickness about 0.05 mm.
